(19) United States
(12) Patent Application Publication
(10) Pub. No.: US 2015/0120592 A1
(43) Pub. Date: Apr. 30, 2015

(54) Laborer connection - conexion jornalera

(71) Applicant: PEDRO DANEURYS PONCEANO, Baltimore, MD (US)

(72) Inventor: PEDRO DANEURYS PONCEANO, Baltimore, MD (US)

(21) Appl. No.: 13/998,419

(22) Filed: Oct. 31, 2013

(51) Int. Cl. G06Q 10/10

(52) U.S. Cl. CPC G06Q 10/1053
USPC 705/321

(57) ABSTRACT

This application is designed specifically to help laborers who want to offer their services and/or skills, and individuals and/or companies who need those services and/or skills, to communicate to each other via electronic communication.

This application will allow laborers offering their services and/or skills, and individuals and/or companies in need of those services and/or skills, to contact, communicate and interact with each other, so both parties may get togheter to arrange an agreement where the laborer can be hired by the other individual or company to perform a job.

The below described claim methods refer to a software application that facilitates contact between two parties, one offering certain expertise, skill or labor, and the other requiring such a service.

This can be accomplished using an application that employs the use of a database and a notification system that can be accessed by its subscribers, utilizing a mobile telephone device, mobile tablet, desktop computer, laptop computer; it may also be accessed via landline through a customer service representative.

1. Application where an individual or company may search for profile contacts by phone (mobile, landline, etc.) text message, or email, for individual or groups of interest.

2. Application where an individual or group that has the qualifications, skills or expertise may be contacted by phone (mobile, landline, etc.) text message, or email, by a company or individual requiring such a the service utilizing information obtained through this application.

3. Application where method of claims 1, 2 and/or 3 are used to find potential candidates and physical location as to where either one of the parties can be located.

4. Application where method of claims 1 and/or 2 are used to send a notification to either party, by phone (mobile, landline, etc.) text message or email or through the application to the other parties' profile.

5. Application where method of claims 1, 2, 3 and/or 4 can be executed utilizing a desktop computer, laptop computer, mobile, telephone, tablet or 3^{rd} party.

6. Application that utilizes method of claim 1, 2, 3, 4 or 5 where company, group or individual do not give personal information to the other party, but prefer to only be contacted through said application by receiving notification on their profile.

7. Application where method of claims 1, 2, 3, 4 and/or 5 can be utilized when an individual or party gives personal information to be contacted directly.

8. Application where method of claims 1,2, 3, 4, 5, 6 and/or 7 can be accessed via landline telephone service or mobile telephone service to search for candidates, with help from a customer service representative.
